(19) United States
(12) Patent Application Publication
(10) Pub. No.: US 2024/0346327 A1
(43) Pub. Date: Oct. 17, 2024

(54) ONLINE OPTIMIZATION FOR JOINT COMPUTATION AND COMMUNICATION IN EDGE LEARNING

(71) Applicant: Telefonaktiebolaget LM Ericsson (publ), Stockholm (SE)

(72) Inventors: Juncheng WANG, Toronto (CA); Ben LIANG, Whitby (CA); Min DONG, Whitby (CA); Gary BOUDREAU, Kanata (CA); Hatem ABOU-ZEID, Calgary (CA)

(21) Appl. No.: 18/292,178

(22) PCT Filed: Jul. 29, 2022
(86) PCT No.: PCT/IB2022/057077

§ 371 Date: Jan. 25, 2024

Related U.S. Application Data
(60) Provisional application No. 63/227,739, filed on Jul. 30, 2021.

(51) Int. Cl. G06N 3/098

(52) U.S. Cl. CPC G06N 3/098

(57) ABSTRACT

A method, system and apparatus are disclosed. An edge node configured to communicate with a plurality of wireless devices (WDs) is described. The edge node includes a communication interface configured to receive a plurality of signal vectors from the plurality of WDs, where the plurality of signal vectors is based on a plurality of updated local models associated with the plurality of WDs. The edge node also includes processing circuitry in communication with the communication interface, where the processing circuitry is configured to update a global model based at least on the plurality of signal vectors; and cause at least one transmission of the updated global model to the plurality of WDs.

### TECHNICAL FIELD

The present disclosure relates to wireless communications, and in particular, to model optimization such as for, for example, Federated Learning (FL) in wireless edge networks.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

### Background on Federated Learning (FL)

Machine learning schemes typically require centralized model training based on a massive dataset available at a data center or a cloud server. In wireless edge networks, wireless devices collect data that can be used to train machine learning models. This motivates new machine leaning technologies at edge servers and devices, collectively called edge learning. The migration of learning at central clouds (e.g., cloud networks, nodes in cloud networks, etc.) to the edge benefits from the information exchange between wireless devices and edge servers/nodes. However, scarcity of communication resources can result in a communication bottleneck to train an accurate machine learning model at the edge (i.e., at an edge server/node). Furthermore, due to privacy concerns, it is desirable to keep data locally at the wireless devices. Communication-efficient distributed learning algorithms that integrate techniques from two different areas, i.e., machine learning and communications, may be applied in these edge learning scenarios.

As a distributed learning scheme, federated learning (FL) allows local devices to collaboratively learn a global model without sending local data to the server. In FL, one operation is to aggregate local models sent from local devices as a global model at the server. To reduce the communication overhead, a machine learning literature mainly focuses on quantification, sparsification, and local updates. These approaches assume error-free transmission and ignore the physical wired or wireless communication layer.

### Background on FL in Wireless Edge Networks

The fading nature of wireless channels and the scarcity of radio resources may result in a communication bottleneck to train an accurate machine learning model at the wireless edge. Assuming error-free transmission, one existing work proposed adaptive global model aggregation under resource constraints for FL. The latency and energy trade-offs between computation and communication have been investigated, using conventional digital coded transmission with orthogonal multiple access (OMA).

Observing that it is sufficient to compute a weighted sum of the local models to update the global model at the server, one or more existing works proposes to employ analog aggregation over a multiple access channel (MAC). Such over-the-air (OTA) computation takes advantage of the superposition property of wireless channels via simultaneous transmissions of the local models, reducing latency and bandwidth requirement compared with the conventional orthogonal multiple access (OMA). To further reduce the communication latency and improve the bandwidth efficiency, the superposition property of a MAC is exploited to perform analog aggregation in FL. In one existing work, truncated local model parameters were scheduled for aggregation based on the channel conditions. Receiver beamforming design was studied to maximize the number of wireless devices for model aggregation at each iteration. In another existing work, the convergence of an analog model aggregation algorithm was studied for strongly convex loss functions.

Other works focused on analog gradient aggregation in FL. Gradient quantization and sparsification were exploited for compressed analog aggregation over a static and fading MAC, respectively. The convergence of the analog gradient aggregation algorithm was studied with sparsified and full gradients, respectively. Power allocation was investigated to achieve differential privacy. Gradient statistics aware power control has been proposed for aggregation error minimization. In another existing work, the aggregation error caused by a noisy channel and gradient compression was minimized through power allocation at each iteration.

These various existing works on FL over wireless edge networks alternate model updating and wireless transmission at each iteration of the model training. Such separate offline optimization of computation and communication does not fully account for the mutual effect between computation and communication over time. Furthermore, most existing works focus on per-iteration optimization problems with short-term transmit power constraints. In wireless edge networks, the long-term transmit power is an important indicator of energy usage at wireless devices.

In addition, a general Lyapunov optimization technique and an online convex optimization technique have been applied to solve various online problems in wireless systems. For example, online power control for wireless transmission with energy harvesting and storage was studied in an existing work. Online precoding design for non-virtualized and virtualized multi antenna systems were investigated in several existing works, respectively. Online network resource allocation with delayed information was studied in an existing work. Under the Lyapunov optimization framework, a weighted sum of the loss and constraint functions is minimized at each iteration. However, for machine learning tasks, directly minimizing the loss functions means finding the optimal model, which is difficult in general. Furthermore, the standard Lyapunov optimization requires centralized implementation, which does not apply to FL based on local data.

Further, it is challenging to address the problem of joint online optimization of computation and communication at the wireless edge (e.g., at an edge server/node). First, noisy wireless channels can create communication errors in analog aggregation of the local models, and these errors are accumulated in the model training process over time. Second, individual long-term transmit power constraints impact the model accuracy and the convergence of model training. Third, due to the fading nature of wireless channels, both model training and power allocation should be channel-aware and online. Finally, existing algorithms fail to provide performance guarantees on both the computation and communication performance metrics.

### SUMMARY

Some embodiments advantageously provide methods, systems, and apparatuses for model optimization such as for, for example, Federated Learning (FL) in wireless edge networks.

Existing works on federated learning at the wireless edge rely on separately optimizing the training of the global model and wireless transmission of the local models.

In one or more embodiments, FL with analog aggregation over noisy wireless fading channels is formulated as an online optimization problem, towards the objective of minimizing the accumulated training loss while satisfying individual long-term transmit power constraints. Thus, both computation and communication performance metrics are advantageously considered. The joint online optimization of computation and communication at wireless edge node of the present disclosure are not described in existing works.

One or more embodiments provide an algorithm, referred to as an Online Model Updating for Analog Aggregation (OMUAA), which integrates FL, OTA computation, and wireless resource allocation. OMUAA (e.g., a component of a communication system configured to perform one or more OMUAA steps) updates local models based on the current local channel state information (CSI). Furthermore, the local models are power aware, and thus they can be directly aggregated over the air without additional transmit power.

One or more embodiments analyze the mutual effect of model training and analog aggregation on the performance of OMUAA over time. The analysis described herein illustrates that OMUAA achieves [symbol] ((1+ρ²+Π_{T}ρ)ϵ) optimality gap with

$$𝒪 ( \frac{1}{{ϵ}^{2}} )$$

convergence time and [symbol] ((1+ρ²)ϵ) long-term power constraint violation with

$$𝒪 ( \frac{1}{{ϵ}^{3}} )$$

convergence time for any approximate level ϵ, where ρ is a measure of channel noise and Π_{T} represents the accumulated variation of the optimal global models over noiseless channels.

Some additional information on the performance evaluation is as follows. The impact of system parameters on the performance of OMUAA based on real-world image classification dataset under typical urban micro-cell Long-Term Evolution (LTE) network settings is studied herein. Further, it is demonstrated OMUAA has a substantial performance advantage over known alternative under different scenarios.

In one or more embodiments, federated learning at a wireless edge network, where multiple power-limited wireless devices collaboratively train a global model. The wireless devices each have their own local data, and they are assisted by an edge server. The global model is trained over a sequence of iterations over time. In each iteration, each wireless device uses the current global model and its own data to update its own local model. Then the edge server updates the global model via analog aggregation of the local models, which are simultaneously transmitted by the wireless devices to the edge server, over a noisy wireless fading multiple access channel. This procedure may be continued until convergence.

In some embodiments, computation (for training of the global model) and communication (for transmission of the local models) in edge learning is jointly optimized, e.g., over time. Accumulated training loss at the edge server may be minimized, e.g., subject to individual long-term transmit power constraints at the wireless devices. Further, an efficient algorithm, termed Online Model Updating for Analog Aggregation (OMUAA), based on current local channel state information (i.e., without knowledge of the channel statistics) is described. In OMUAA, each wireless device updates its local model, considering its impact on both the performance of the global model and on the effectiveness of analog aggregation over a noisy channel.

For performance analysis, the mutual effect of computation and communication is studied (e.g., monitored, determined, analyzed, etc.) over time to derive performance bounds on both the computation and communication performance metrics. Simulation results based on a real-world image classification dataset demonstrate substantial performance gain of OMUAA over the known best alternative, under typical urban micro-cell Long-Term Evolution network settings.

One part of one or more embodiments described herein resemble (i.e., may be based on) concepts of Lyapunov optimization and online convex optimization. The online convex optimization framework has a different system setting with different performance metrics from the teachings of the disclosure.

One or more embodiments focus on FL in a wireless edge network, where multiple wireless devices participate in model training with the assistance of an edge node. Joint online optimization of FL and analog aggregation over noisy wireless fading channels are considered/described in one or more embodiments. One goal of one or more embodiments is to minimize the accumulated training loss at the edge node while satisfying the individual long-term transmit power constraints at the wireless device.

According to one aspect, an edge node configured to communicate with a plurality of wireless devices (WDs) is described. The edge node includes a communication interface configured to receive a plurality of signal vectors from the plurality of WDs, where the plurality of signal vectors is based on a plurality of updated local models associated with the plurality of WDs. The edge node also includes processing circuitry in communication with the communication interface, where the processing circuitry is configured to update a global model based at least on the plurality of signal vectors; and cause at least one transmission of the updated global model to the plurality of WDs.

In some embodiments, the processing circuitry is further configured to initialize at least one of a first step-size parameter, a second step-size parameter, and a power regularization factor. The plurality of updated local models are based at least in part on the initialized at least one of the first step-size parameter, the second step-size parameter, and the power regularization factor. The communication interface is further configured to transmit the initialized at least one of the first step-size parameter, the second step-size parameter, and the power regularization factor.

In some other embodiments, the global model is updated using model averaging based on at least one of a local gradient and a global gradient descent. In an embodiment, each of the plurality of updated local models is based at least in part on respective local channel state information (CSI) and local data. In another embodiment, the received plurality of signal vectors is based on at least one updated local virtual queue. In some embodiments, the processing circuitry is further configured to recover a version of the global model based on the received plurality of signal vectors.

In some other embodiments, the recovered version of the global model is a noisy version of the global model based at least in part on a communication error. In an embodiment, the communication error is based at least in part on a noise value bounded by a predetermined threshold. In another embodiment, updating of the global model includes computing a weighted sum of the plurality of updated local models. In some embodiments, the updating of the global model is based on a federated learning.

According to another aspect, a method in an edge node configured to communicate with a plurality of wireless devices (WDs) is described. The method includes receiving a plurality of signal vectors from the plurality of WDs, where the plurality of signal vectors is based on a plurality of updated local models associated with the plurality of WDs; updating a global model based at least on the plurality of signal vectors; and causing at least one transmission of the updated global model to the plurality of WDs.

In some embodiments, the method further includes initializing at least one of a first step-size parameter, a second step-size parameter, and a power regularization factor; and transmitting the initialized at least one of the first step-size parameter, the second step-size parameter, and the power regularization factor. In some other embodiments, the global model is updated using model averaging based on at least one of a local gradient and a global gradient descent. In one embodiment, each of the plurality of updated local models is based at least in part on respective local channel state information (CSI) and local data. In another embodiment, the received plurality of signal vectors is based on at least one updated local virtual queue.

In some embodiments, the method further includes recovering a version of the global model based on the received plurality of signal vectors. In some other embodiments, the recovered version of the global model is a noisy version of the global model based at least in part on a communication error. In an embodiment, the communication error is based at least in part on a noise value bounded by a predetermined threshold. In another embodiment, updating of the global model includes computing a weighted sum of the plurality of updated local models. In some embodiments, the updating of the global model is based on a federated learning.

According to one aspect, a wireless device (WD) configured to communicate with an edge node is described. The WD includes processing circuitry configured to update a local model based at least in part on a distributed per-iteration optimization function using local channel state information (CSI) and local data. The WD further includes a radio interface in communication with the processing circuitry, where the radio interface is configured to transmit at least one signal vector to the edge node, the at least one signal vector being based on the updated local model; and receive an updated global model, the updated global model being updated based at least in part on the at least one signal vector, the updated global model being channel and power aware.

In some embodiments, the radio interface is further configured to receive at least one of a first step-size parameter, a second step-size parameter, and a power regularization factor initialized at the edge node. The received at least one of the first step-size parameter, the second step-size parameter, and the power regularization factor are usable by the WD to update the local model. In some other embodiments, the processing circuitry is further configured to initialize at least one of the local model, a global model, and a local virtual queue. In an embodiment, the processing circuitry is further configured to update the local virtual queue based on a long-term transmit power constraint. In another embodiment, the long-term transmit power constraint is based on a local channel state and the local model.

In some embodiments, the processing circuitry is further configured to determine the distributed per-iteration optimization function using the local CSI and the local data. In some other embodiments, the processing circuitry is further configured to determine the at least one signal vector based on the local model, at least one power regularization factor, and at least one channel inversion vector. In one embodiment, updating the local model is further based on a recovered version of one global model. In another embodiment, the updated global model is based on a computed weighted sum of a plurality of signal vectors associated with a plurality of wireless devices. The at least one signal vector is part of the plurality of signal vectors, the WD being part of the plurality of WDs. In some embodiments, the updated global model is based on a federated learning.

According to another aspect, a method in a wireless device (WD) configured to communicate with an edge node is described. The method includes updating a local model based at least in part on a distributed per-iteration optimization function using local channel state information, CSI, and local data; transmitting at least one signal vector to the edge node, where the at least one signal vector is based on the updated local model; and receiving an updated global model. The updated global model is updated based at least in part on the at least one signal vector. Further, the updated global model is channel and power aware.

In some embodiments, the method further includes receiving at least one of a first step-size parameter, a second step-size parameter, and a power regularization factor initialized at the edge node. The received at least one of the first step-size parameter, the second step-size parameter, and the power regularization factor are usable by the WD to update the local model. In some other embodiments, the method further includes initializing at least one of the local model, a global model, and a local virtual queue. In an embodiment, the method further includes updating the local virtual queue based on a long-term transmit power constraint. In another embodiments, the long-term transmit power constraint is based on a local channel state and the local model.

In some embodiments, the method further includes determining the distributed per-iteration optimization function using the local CSI and the local data. In some other embodiments, the method further includes determining the at least one signal vector based on the local model, at least one power regularization factor, and at least one channel inversion vector. In an embodiment, updating the local model is further based on a recovered version of one global model. In another embodiment, the updated global model is based on a computed weighted sum of a plurality of signal vectors associated with a plurality of wireless devices. The at least one signal vector is part of the plurality of signal vectors, the WD being part of the plurality of WDs. In some embodiments, the updated global model is based on a federated learning.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system according to principles disclosed herein;

FIG. 2 is a block diagram of several entities in the communication system according to some embodiments of the present disclosure;

FIG. 3 is a flowchart of an example process in an edge node according to some embodiments of the present disclosure;

FIG. 4 is a flowchart of an example process in a wireless device according to some embodiments of the present disclosure;

FIG. 5 is a flowchart of another example process in an edge node according to some embodiments of the present disclosure;

FIG. 6 is a flowchart of another example process in a wireless device according to some embodiments of the present disclosure;

FIG. 7 is a flowchart of another example process in a wireless device according to some embodiments of the present disclosure;

FIG. 8 is a flowchart of another example process in an edge node according to some embodiments of the present disclosure; and

FIG. 9 is a diagram of example federated learning at the edge node according to some embodiments of the present disclosure.

FIG. 10 is a diagram of example test accuracy values for various iterations according to some embodiments of the present disclosure;

FIG. 11 is a diagram of example training loss values for various iterations according to some embodiments of the present disclosure;

FIG. 12 is a diagram of example transmit power values for various iterations according to some embodiments of the present disclosure;

FIG. 13 is a diagram of an example test accuracy vs. long-term transmit power limit according to some embodiments of the present disclosure; and

FIG. 14 is a diagram of test accuracy vs. distance to the edge node with different P values according to some embodiments of the present disclosure.

### DETAILED DESCRIPTION

Before describing in detail example embodiments, it is noted that the embodiments reside primarily in combinations of apparatus components and processing steps related to model optimization such as for, for example, Federated Learning (FL), e.g., in wireless edge networks. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate, and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. In some embodiments, a network node may comprise/be an edge node. However, an edge node is not limited as such and may be any standalone node. Further, an edge node may be configured to perform steps (e.g., edge computing) associated with a wireless edge network (such as one or more networks associated with the communication system of the present disclosure).

In some other embodiments, the term “radio node” used herein may be used to also denote a wireless device (WD) such as a radio network node.

In some embodiments, the non-limiting terms wireless device (WD) or a user equipment (UE) are used interchangeably. The WD herein can be any type of wireless device capable of communicating with a network node and/or edge node and/or another WD over radio signals, such as wireless device (WD). The WD may also be a radio communication device, target device, device to device (D2D) WD, machine type WD or WD capable of machine-to-machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Transmitting in downlink may pertain to transmission from the network or network node to the wireless device. Transmitting in uplink may pertain to transmission from the wireless device to the network or network node. Transmitting in sidelink may pertain to (direct) transmission from one wireless device to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to model optimization such as for, for example, Federated Learning (FL) in wireless edge networks.

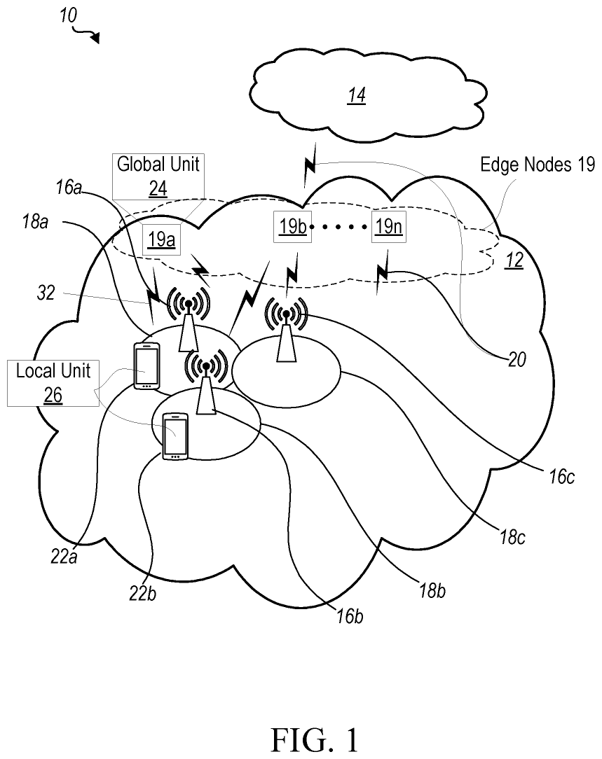

Referring to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Access network 12 includes one or more edge nodes 19a-19n (referred to collectively and/or interchangeably as one or more of edge node 19 (e.g., edge server) that may form one or more edge networks. In one or more embodiments, edge node 19 is at the access/edge of access network 12 and/or may be co-located with network node 16. Also, the techniques disclosed herein may also be beneficial for use in another type of network with a similar arrangement, such as a data network such as to provide one or more advantages described herein to other types of networks.

Each network node 16a, 16b, 16c is connectable to the edge node 19 and/or the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD 22 is in the coverage area or where a sole WD 22 is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 (and/or edge node 19) and more than one type of network node 16 (and/or more than one type of edge node 19). For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

An edge node 19 is configured to include a global unit 24 which is configured to perform one or more edge node 19 functions as described herein such as with respect to global model optimization such as for, for example, Federated Learning (FL) in wireless edge networks. A wireless device 22 is configured to include a local unit 26 which is configured to perform one or more wireless device 22 functions as described herein such as with respect to local model optimization such as for FL in wireless edge networks.

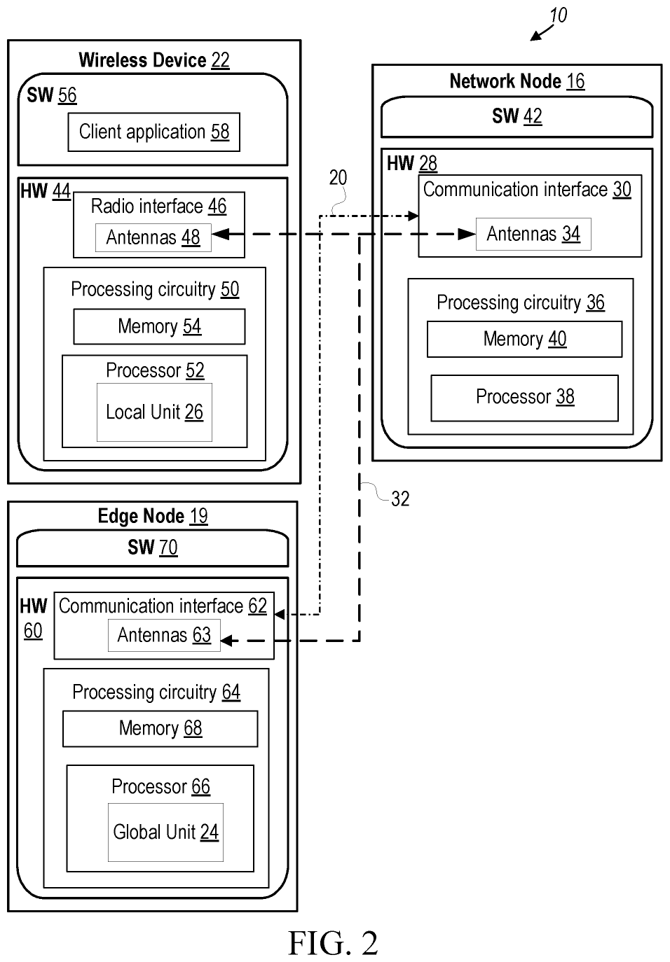

Example implementations, in accordance with an embodiment, of the WD 22, network node 16 and edge node 19 discussed in the preceding paragraphs will now be described with reference to FIG. 2.

The communication system 10 includes a network node 16 provided in a communication system 10 and including hardware 28 enabling it to communicate with the WD 22. The hardware 28 may include a communication interface 30 for setting up and maintaining at least a wireless connection 32 with a WD 22 located in a coverage area 18 served by the network node 16. The communication interface 30 may be formed as or may include, for example, one or more RF transmitters, one or more RF receivers, and/or one or more RF transceivers. The communication interface 30 includes an array of antennas 34 to radiate and receive signal(s) carrying electromagnetic waves. In one or more embodiments, network node 16 may communicate with edge node 19 via one or more of communication interface 30 (e.g., via non-wireless backhaul link) and antennas 34.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16.

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. In one or more embodiments, WD 22 may set up and maintain a wireless connection 32 with edge node 19. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include local unit 26 which is configured to model optimization such as for, for example, Federated Learning (FL) in wireless edge networks.

The communication system 10 includes an edge node 19 provided in a communication system 10 and including hardware 60 enabling it to communicate with the WD 22 and/or network node 16. The hardware 60 may include a communication interface 62 for setting up and maintaining at least a wireless connection 32 with a WD 22 and/or network node 16. The communication interface 62 may be formed as or may include, for example, one or more RF transmitters, one or more RF receivers, and/or one or more RF transceivers. The communication interface 62 includes an array of antennas 63 to radiate and receive signal(s) carrying electromagnetic waves. In one or more embodiments, edge node 19 may communicate with network node via one or more of communication interface 62 (e.g., via non-wireless backhaul link) and antennas 63.

In the embodiment shown, the hardware 60 of the edge node 19 further includes processing circuitry 64. The processing circuitry 64 may include a processor 66 and a memory 68. In particular, in addition to or instead of a processor, such as a central processing unit, and memory, the processing circuitry 64 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 66 may be configured to access (e.g., write to and/or read from) the memory 68, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the edge node 19 further has software 70 stored internally in, for example, memory 68, or stored in external memory (e.g., database, storage array, network storage device, etc.) accessible by the edge node 19 via an external connection. The software 70 may be executable by the processing circuitry 64. The processing circuitry 64 may be configured to control any of the methods and/or processes described herein and/or to cause such methods, and/or processes to be performed, e.g., by edge node 19. Processor 66 corresponds to one or more processors 66 for performing edge node 19 functions described herein. The memory 68 is configured to store data, programmatic software code and/or other information described herein. In some embodiments, the software 70 may include instructions that, when executed by the processor 66 and/or processing circuitry 64, causes the processor 66 and/or processing circuitry 64 to perform the processes described herein with respect to edge node 19. For example, the processing circuitry 64 of the edge node 19 may include global unit 24 which is configured to model optimization such as for, for example, Federated Learning (FL) in wireless edge networks.

In some embodiments, the inner workings of the network node 16, edge node 19 and WD 22 may be as shown in FIG. 2 and independently, the surrounding network topology may be that of FIG. 1.

The wireless connection 32 between the WD 22 and the network node 16 and/or edge node 19 is in accordance with the teachings of the embodiments described throughout this disclosure.

Although FIGS. 1 and 2 show various “units” such as global unit 24 and local unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

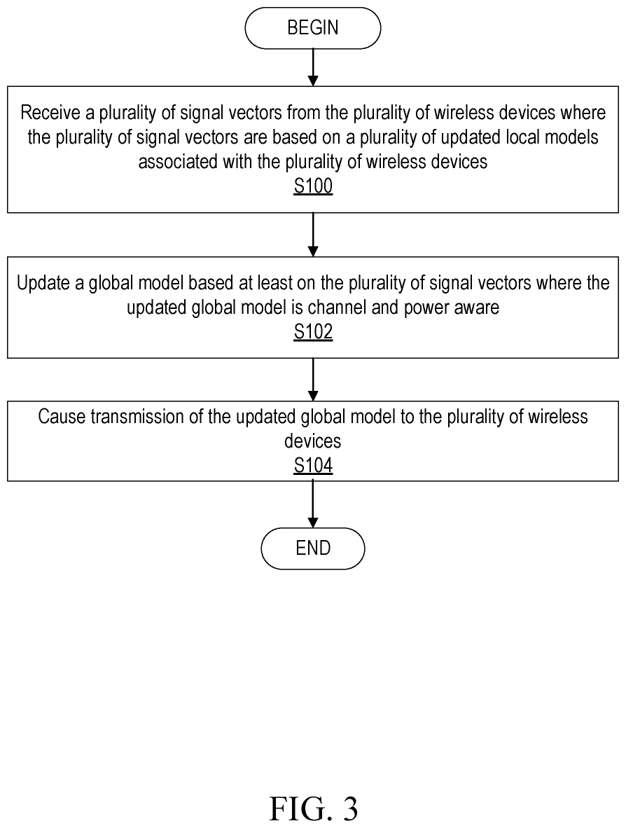

FIG. 3 is a flowchart of an example process in an edge node 19 according to some embodiments of the present disclosure. One or more blocks described herein may be performed by one or more elements of edge node 19 such as by one or more of processing circuitry 64 (including the global unit 24), processor 66, and/or communication interface 62. Edge node 19 is configured to receive (Block S100) a plurality of signal vectors from the plurality of wireless devices 22 where the plurality of signal vectors is based on a plurality of updated local models associated with the plurality of wireless devices 22, as described herein. The edge node 19 is configured to update (Block S102) a global model based at least on the plurality of signal vectors where the updated global model is channel and power aware, as described herein. The edge node 19 is configured to cause (Block S104) transmission of the updated global model to the plurality of wireless devices 22, as described herein.

According to one or more embodiments, the updating of the global model includes computing a weighted sum of the plurality of signal vectors. According to one or more embodiments, the processing circuitry 64 is further configured to schedule at least one transmission to at least one of the plurality of wireless devices 22 based at least on the updated global model. According to one or more embodiments, the updating of the global model is based on a federated learning at the edge node 19.

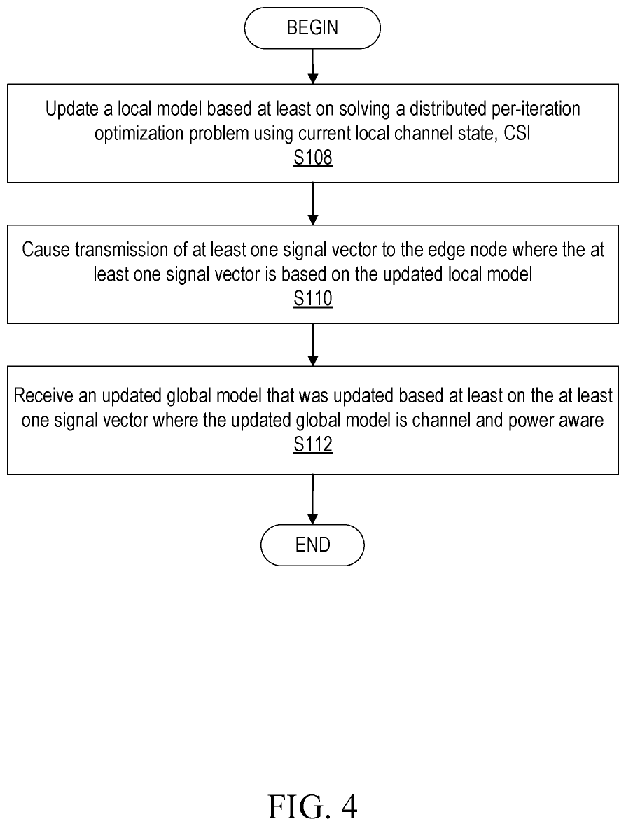

FIG. 4 is a flowchart of an example process in a wireless device 22 according to some embodiments of the present disclosure. One or more blocks described herein may be performed by one or more elements of wireless device 22 such as by one or more of processing circuitry 50 (including the local unit 26), processor 52, and/or radio interface 46. Wireless device 22 is configured to update (Block S108) a local model based at least on solving a distributed per-iteration optimization problem using current local channel state, CSI, as described herein. Wireless device 22 is configured to cause (Block S110) transmission of at least one signal vector to the edge node 19, the at least one signal vector being based on the updated local model, as described herein. Wireless device 22 is configured to receive (Block S112) an updated global model that was updated based at least on the at least one signal vector, the updated global model being channel and power aware, as described herein.

According to one or more embodiments, the updated global model is based on a computed weighted sum of the plurality of signal vectors associated with a plurality of wireless devices 22. According to one or more embodiments, the processing circuitry 50 is further configured to receive a scheduling of at least one transmission that is scheduled based at least on the updated global model. According to one or more embodiments, the updated global model is based on a federated learning at the edge node 19.

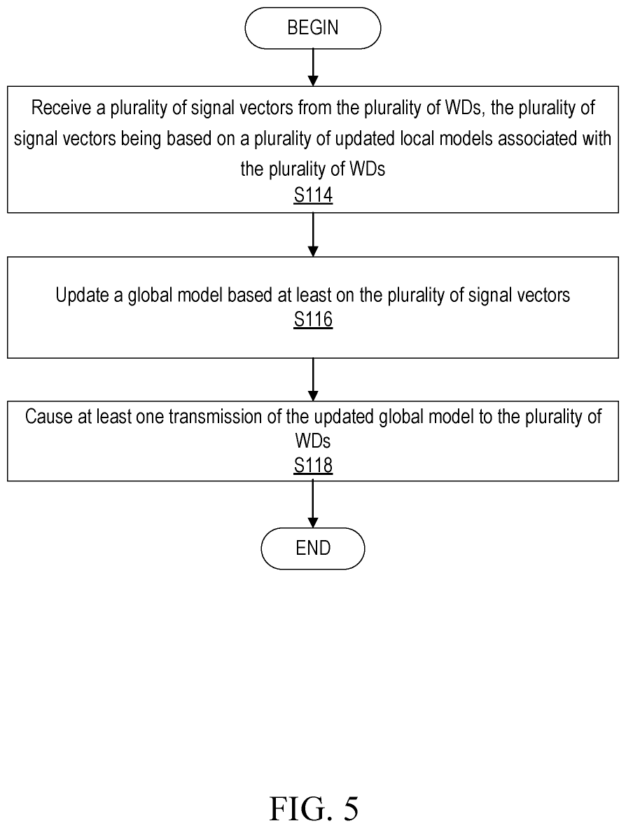

FIG. 5 is a flowchart of an example process in an edge node 19 according to some embodiments of the present disclosure. One or more blocks described herein may be performed by one or more elements of edge node 19 such as by one or more of processing circuitry 64 (including the global unit 24), processor 66, and/or communication interface 62. Edge node, such as via 19 processing circuitry 64 (including the global unit 24) and/or processor 66 and/or communication interface 62, is configured to receive (Block S114) a plurality of signal vectors from the plurality of WDs 22, where the plurality of signal vectors are based on a plurality of updated local models associated with the plurality of WDs 22; update (Block S116) a global model based at least on the plurality of signal vectors; and cause (Block S118) at least one transmission of the updated global model to the plurality of WDs 22.

In some embodiments, the method further includes initializing at least one of a first step-size parameter, a second step-size parameter, and a power regularization factor, the plurality of updated local models being based at least in part on the initialized at least one of the first step-size parameter, the second step-size parameter, and the power regularization factor; and transmitting the initialized at least one of the first step-size parameter, the second step-size parameter, and the power regularization factor. For example, one or more the two step-size parameters α,γ and the power regularization factor λ may be used to determine local models.

In some other embodiments, the global model is updated using model averaging based on at least one of a local gradient and a global gradient descent. For example, the method may use equation (11) (e.g., in the context of analog aggregation) to perform model averaging. In one embodiment, each of the plurality of updated local models is based at least in part on respective local channel state information (CSI) and local data. In another embodiment, the received plurality of signal vectors is based on at least one updated local virtual queue. In some embodiments, the method further includes recovering a version of the global model based on the received plurality of signal vectors.

In some other embodiments, the recovered version of the global model is a noisy version of the global model based at least in part on a communication error. For example, the noisy version of the global model may be in equation (11), and the noiseless version of the global model in equation (6). In an embodiment, the communication error is based at least in part on a noise value bounded by a predetermined threshold. In another embodiment, updating of the global model includes computing a weighted sum of the plurality of updated local models. In some embodiments, the updating of the global model is based on a federated learning.

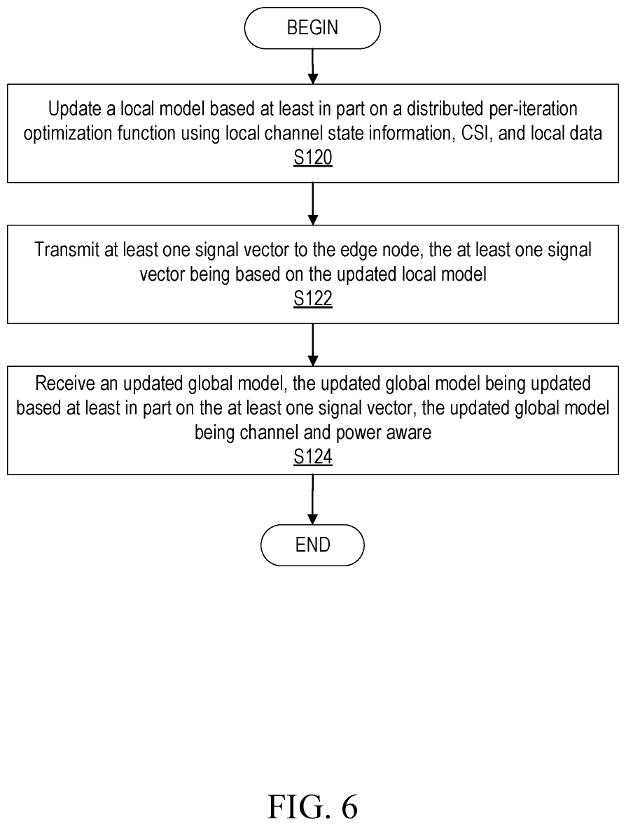

FIG. 6 is a flowchart of an example process in a wireless device 22 according to some embodiments of the present disclosure. One or more blocks described herein may be performed by one or more elements of wireless device 22 such as by one or more of processing circuitry 50 (including the local unit 26), processor 52, and/or radio interface 46. Wireless device 22, such as via one or more of processing circuitry 50 (including the local unit 26), processor 52, and/or radio interface 46, is configured to update (Block S120) a local model based at least in part on a distributed per-iteration optimization function using local channel state information (CSI) and local data; transmit (Block S122) at least one signal vector to the edge node 19, the at least one signal vector being based on the updated local model; and receive (Block S124) an updated global model. The updated global model is updated based at least in part on the at least one signal vector. The updated global model is channel and power aware.

In some embodiments, the method further includes receiving at least one of a first step-size parameter, a second step-size parameter, and a power regularization factor initialized at the edge node 19. The received at least one of the first step-size parameter, the second step-size parameter, and the power regularization factor are usable by the WD 22 to update the local model. In some other embodiments, the method further includes initializing at least one of the local model, a global model, and a local virtual queue. In an embodiment, the method further includes updating the local virtual queue based on a long-term transmit power constraint. In another embodiments, the long-term transmit power constraint is based on a local channel state and the local model.

In some embodiments, the method further includes determining the distributed per-iteration optimization function using the local CSI and the local data. In some other embodiments, the method further includes determining the at least one signal vector based on the local model, at least one power regularization factor, and at least one channel inversion vector. In an embodiment, updating the local model is further based on a recovered version of one global model. In another embodiment, the updated global model is based on a computed weighted sum of a plurality of signal vectors associated with a plurality of wireless devices 22. The at least one signal vector is part of the plurality of signal vectors, the WD 22 being part of the plurality of WDs 22. In some embodiments, the updated global model is based on a federated learning.

Having generally described arrangements for model optimization such as for, for example, Federated Learning (FL) in wireless edge networks, details for these arrangements, functions and processes are provided as follows, and which may be implemented by the network node 16 (and/or any of its components, e.g., shown in FIG. 2) and/or edge node 19 (and/or any of its components, e.g., shown in FIG. 2) and/or wireless device 22 (and/or any of its components, e.g., shown in FIG. 2).

Some embodiments provide model optimization such as for, for example, Federated Learning (FL) in wireless edge networks.

### 1. SYSTEM MODEL AND PROBLEM FORMULATION

### 1.1 Federated Learning System

FL is directed to training a global machine learning model based on the local data at multiple local devices. To preserve data privacy, instead of collecting the raw data from local devices to train the global model, the FL algorithm described herein updates the global model by computing the weighted sum of the locally updated models received from the local devices. Through local gradient descent, the local models are updated at local devices to minimize the training loss that measures the training performance.

### 1.1.1 Learning Objective

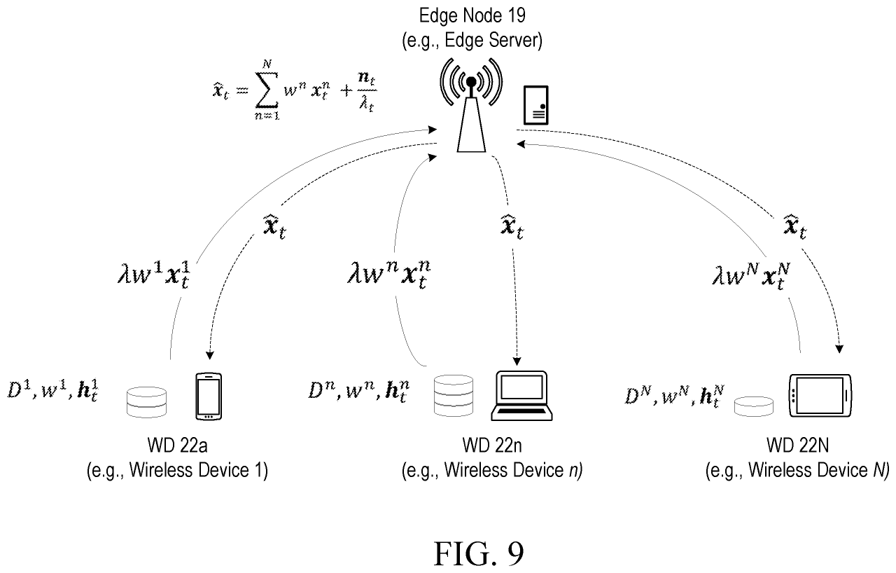

In one or more embodiments, a wireless edge network (e.g., access network 12 and/or core network 14) formed by N wireless devices 22 (also referred to as wireless device n) and an edge node 19 as shown in FIGS. 1 and 9. Each wireless device n collects its local training dataset denoted by [symbol] ⁿ. The i-th data sample in [symbol] ⁿ is represented by (u^{n,i}, u^{n,i}), where u^{n,i} is a data feature vector and v^{n,i} is the true label for this data sample. One FL objective is for the edge node 19 to learn a global model (e.g., a neural network), represented by the vector x∈ [symbol] ^{d}, which generates the true label for any data feature vector. The global model is learned based on the local training datasets.

For a given global model x∈ [symbol] ^{d}, a sample-wise loss function l(x; u^{n,i}, v^{n,i}): [symbol] ^{d}→ [symbol] associated with every data sample is defined. The loss function is generally defined to represent the training error. For example, it can be defined as the logistic regression to measure the prediction accuracy on data vector u^{n,i} with respect to its true label v^{n,i}.

The local loss function fⁿ(x): [symbol] ^{d}→ [symbol] for each wireless device n is defined as the averaged loss incurred by the local dataset [symbol] ⁿ, given by

$${f}^{n} ( x ) = \frac{1}{\vert {𝒟}^{n} \vert} {\sum }_{i = 1}^{\vert {𝒟}^{n} \vert} l ( x ; {u}^{n , i} , {v}^{n , i} ) \qquad ( 1 )$$

where | [symbol] ⁿ| is the cardinality of dataset [symbol] ⁿ. Let [symbol] =Uₙ₌₁^{N}{ [symbol] ⁿ} denote the global dataset with | [symbol] |=Σₙ₌₁^{N}| [symbol] ⁿ|. The global loss function f(x): [symbol] ^{d}→ [symbol] can be written as

$$f ( x ) = {\sum }_{n = 1}^{N} {w}^{n} {f}^{n} ( x ) \qquad ( 2 )$$

where

$${w}^{n} = \frac{\vert {𝒟}^{n} \vert}{\vert 𝒟 \vert}$$

is the weight on wireless device n that satisfies Σₙ₌₁^{N}wⁿ=1. This is equivalent to the averaged loss incurred by the global dataset [symbol] .

The learning process aims at finding an optimal global model x* by solving the following optimization problem

$$x * ∈ arg {min}_{x} \{ f ( x ) \} . \qquad ( 3 )$$

One could compute x* after uploading all the distributed datasets to the edge node 19. However, such a centralized approach may be undesirable, as it causes privacy issues and incurs a lot of communication overhead.

### 1.1.2 Error-Free Federated Learning Algorithm

FL over noiseless channels can be seen as an iterative distributed learning process that solves the above problem based on the local datasets at wireless devices 22. At each iteration t, the edge node 19 broadcasts the current global model xₜ₋₁ to all the N wireless devices 22. Each wireless device n calculates the local gradient ∇fⁿ(xₜ₋₁) based on the local dataset [symbol] ⁿ to update its local model xₜⁿ via gradient descent, given by

$${x}_{t}^{n} = {x}_{t - 1} - α ∇ {f}^{n} ( {x}_{t - 1} ) \qquad ( 4 )$$

where α is a step-size parameter. Equivalently, xₜⁿ are obtained by solving the following optimization problem

$${min}_{x} 〈 ∇ {f}^{n} ( {x}_{t - 1} ) , x - {x}_{t - 1} 〉 + \frac{1}{2 α} {‖ x - {x}_{t - 1} ‖}^{2} . \qquad ( 5 )$$

Remark 1. One may implement stochastic gradient descent (SGD) by sampling a batch dataset [symbol] ₜⁿ⊆ [symbol] ⁿ at each iteration t. Such an implementation generally requires an unbiased independent stochastic gradient at each wireless device n, i.e.,

$$𝔼 \{ ∇ l ( {x}_{t - 1} ; {u}^{n , i} , {v}^{n , i} ) \} = ∇ {f}^{n} ( {x}_{t - 1} ) , ∀ ( {u}^{n , i} , {v}^{n , i} ) ∈ {ℬ}_{t}^{n} , ∀ n ,$$

and therefore suffers from sampling noise in every iteration. The performance of SGD based algorithms have been studied in the machine learning literature. In one or more embodiments described herein, one focus is on the aggregation error caused by noisy wireless fading channels and therefore one or more embodiments consider as an example full gradient descent using a fixed local dataset [symbol] ⁿ at each iteration t. The full gradient descent approach is adopted by the existing works on FL in wireless networks. While the performance analysis described herein is based on full gradient descent, one or more embodiments described herein are not limited to using full gradient descent as other stochastic type analysis may be performed.

After performing local gradient descent, each wireless device n sends its local model xₜⁿ to the edge node 19, which then updates the global model xₜ through model averaging, given by

$${x}_{t} = {\sum }_{n = 1}^{N} {w}^{n} {x}_{t}^{n} . \qquad ( 6 )$$

For a total of T iterations, the FL scheme alternates between local gradient descent in (4) and global model averaging in (6), with an aim to approach x* in (3).

Note that the above FL algorithm assumes error-free communication such that it need not be the algorithm in the disclosure.

Remark 2. Substituting (4) into (6), the model averaging process at the edge node 19 can be expressed as

$${x}_{t} = {x}_{t - 1} - α {\sum }_{n = 1}^{N} {w}^{n} ∇ {f}^{n} ( {x}_{t - 1} ) .$$

This is equivalent to gradient averaging, by uploading the local gradient ∇fⁿ(xₜ₋₁) and performing global gradient descent at the edge node 19 using the averaged gradient. Another equivalent implementation is to send the local update xₜ₋₁−α∇fⁿ(xₜ₋₁) to the edge node 19 and let the edge node 19 calculate the average of all local updates. In one or more embodiments, the model averaging approach is adopted.

### 1.2 Analog Aggregation Over the Air

One observation on the above FL process is that the edge node 19 may only need to compute the weighted sum of local models in (6), without needing to know each local model exactly. This falls into the category of computing a nomographic function (e.g., geometric mean, weighted sum, and Euclidean norm) of distributed data over MAC. Such analog aggregation scheme exploits the superposition property of a MAC to compute the target function via concurrent transmission. It has been proposed for analog network coding and was extended to OTA FL. Perfect synchronization between the wireless devices 22 and the edge node 19 is assumed. The synchronization issue has been considered in one existing work by modulating the information into the transmit power and performing multiple redundant transmissions, such that only coarse block-synchronization is needed for analog aggregation. Alternatively, the edge node 19 can broadcast a shared clock to all mobile devices to achieve synchronization.

In one or more embodiments, the channel between the N wireless devices 22 and the edge node 19 is modeled as a wireless fading MAC. The whole bandwidth is divided into S orthogonal sub-carriers via orthogonal frequency-division multiplexing (OFDM) modulation. At the t-th iteration, all the local models {xₜⁿ} generated by the N wireless devices 22 are transmitted simultaneously to the edge node 19, occupying a total of

$$\\ M = ⌈ \frac{d}{S} ⌉$$

transmission frames. Let h_{t,m}ⁿ−[h_{t,m}^{n,1}, . . . , h_{t,m}^{n,S}]^{T}∈ [symbol] ^{S} be the channel state vector between wireless device n and the edge node 19 at the m-th transmission frame of the t-th iteration. A block fading channel model may be assumed, where h_{t,m}ⁿ over transmission frame m (and iteration t) is independent and identically distributed. The distribution of h_{t,m}ⁿ is unknown and can be arbitrary.

The received signal vector y_{t,m}∈ [symbol] ^{S} by the edge node 19 at the m-th transmission frame of the t-th iteration is given by

$${y}_{t , m} = {\sum }_{n = 1}^{N} {h}_{t , m}^{n} ∘ {s}_{t , m}^{n} + {z}_{t , m} . \qquad ( 7 )$$

where s_{t,m}ⁿ∈ [symbol] ^{S} is the transmitted signal vector by wireless device n and z_{t,m}˜ [symbol] (0, σ²I) is the Gaussian noise vector. Let

$${h}_{t}^{n} = {[ {h}_{t , 1}^{{n}^{T}} , … , {h}_{t , M}^{{n}^{T}} ]}^{T}$$

be the channel state vector over the M transmission frames. The received signal vector yₜ [symbol] [y_{t,1}^{T}, . . . , y_{t,M}^{T}]^{T} over the M transmission frames can be expressed as

$${y}_{t} = {\sum }_{n = 1}^{N} {h}_{t}^{n} ∘ {s}_{t}^{n} + {z}_{t} \qquad ( 8 )$$

where

$${s}_{t}^{n} {=}^{Δ} {[ {s}_{t , 1}^{{n}^{T}} , … , {s}_{t , M}^{{n}^{T}} ]}^{T} and {z}_{t} {=}^{Δ} {[ {z}_{t , 1} , … , {z}_{t , M} ]}^{T} .$$

To recover the global model in equation (6) over noisy wireless fading channels, in the following, appropriate pre-and post-processing at the wireless devices 22 and edge node 19 are described, respectively.

### 1.2.1 Pre-Processing at Mobile Devices

It may be assumed that perfect local CSI is available at each wireless device 22 as in existing works on OTA FL. Let

$${b}_{t , m}^{n} = {[ \frac{{h}_{t , m}^{n , {1}^{*}}}{{\vert {h}_{t , m}^{n , 1} \vert}^{2}} , … , \frac{{h}_{t , m}^{n , {S}^{*}}}{{\vert {h}_{t , m}^{n , S} \vert}^{2}} ]}^{T}$$

∈ [symbol] ^{S} be the channel inversion vector with respect to h_{t,m}ⁿ. At each iteration t, each wireless device n performs the following pre-processing to generate its transmitted signal vector sₜⁿ, given by

$${s}_{t}^{n} = {λ}_{t} {w}^{n} {b}_{t}^{n} ∘ {x}_{t}^{n} \qquad ( 9 )$$

where λₜ is a power-regularization factor and

$${b}_{t}^{n} {=}^{Δ} {[ {b}_{t , 1}^{{n}^{T}} , … , {b}_{t , M}^{{n}^{T}} ]}^{T}$$

is the channel inversion vector over the M transmission frames. The averaged transmit power of wireless device n over the M transmission frames at iteration t is thus

$$\frac{1}{M} {‖ {s}_{t}^{n} ‖}^{2} .$$

### 1.2.2 Post-Processing at Edge Server

Substituting (9) into (8), the received signal vector at the edge node 19 can be expressed as

$${y}_{t} = {λ}_{t} {\sum }_{n = 1}^{N} {w}^{n} {x}_{t}^{n} + {z}_{t} . \qquad ( 10 )$$

The edge node 19 then performs the following post-processing and recovers a noisy version of the global model xₜ in (6), given by

$${\hat{x}}_{t} = \{ \frac{1}{{λ}_{t}} {y}_{t} \} = {x}_{t} + \frac{1}{{λ}_{t}} {n}_{t} \qquad ( 11 )$$

where

$${n}_{t} = \{ {z}_{t} \} ∼ 𝒩 ( 0 , \frac{{σ}^{2}}{2} I ) .$$

The real part of the received signal to recover xₜ is taken. The derivations can be extended to utilize both the real and imaginary part of sub-carriers to recover xₜ. A small λₜ can be used to reduce the transmit power. However, the small λₜ enlarges the communication error

$$\frac{1}{{λ}_{t}} {n}_{t}$$

and thus reduces the receiver signal-to-noise ratio (SNR). For performance analysis, it may be assumed that the noise is bounded by a constant ρ≥0 at any iteration t, given by

$$‖ {n}_{t} ‖ \leq ρ , ∀ t . \qquad ( 12 )$$

The edge node 19 then broadcasts the updated global model \hat{x}ₜ to all the wireless devices 22. It may be assumed that the edge node 19 is not power or bandwidth limited such that \hat{x}ₜ can be received by all the wireless devices in an error-free fashion, before the next iteration.

### 1.3 Problem Formulation

One or more embodiments described herein jointly optimize model training and analog aggregation over time for the above federated edge learning with analog aggregation. For a total of T iterations, the following long-term transmit power constraint is imposed at each wireless device n

$$\frac{1}{T} {\sum }_{t = 1}^{T} 𝔼 \{ \frac{1}{M} {‖ {λ}_{t} {w}^{n} {b}_{t}^{n} \cdot {x}_{t}^{n} ‖}^{2} \} \leq {\overline{P}}^{n} , ∀ n \qquad ( 13 )$$

where the expectation is taken over the randomness of the channel states and P̅ⁿ is the average transmit power limit. Short-term constraints on the local model are also considered and are represented by

$$𝒳 = \{ x : - \overline{x} ≼ x ≼ \overline{x} \} ∈ {ℝ}^{d} \qquad ( 14 )$$

where [symbol] represents pointwise precedence and x̅=x̅1 with x̅ being the limit on the maximum value of the model parameters. It follows that [symbol] is bounded, i.e.,

$$‖ x ‖ \leq R , \qquad ( 15 )$$

$$∀ x ∈ 𝒳$$

where R=\sqrt{d}x̅. In one or more embodiments, [symbol] is imposed to at least in part avoid the transmit power from being infinity.

One or more embodiments select a sequence of local models {xₜⁿ} from [symbol] to minimize the accumulated loss yielded by the noisy global model {\hat{x}ₜ} after analog aggregation at the edge node 19, while ensuring that individual long-term transmit power constraints at the wireless devices 22 are satisfied. This leads to the following stochastic optimization problem:

$$P 1 : {min}_{\{ {x}_{t}^{n} ∈ 𝒳 \}} {lim}_{T \to ∞} \frac{1}{T} {\sum }_{t = 1}^{T} 𝔼 \{ f ( {\hat{x}}_{t} ) \} \qquad ( 16 )$$

$$s . t . {lim}_{T \to ∞} \frac{1}{T} {\sum }_{t = 1}^{T} 𝔼 \{ {g}_{t}^{n} ( {x}_{t}^{n} ) \} \leq 0 , ∀ n$$

where the expectation is taken over the randomness of the channel states and

$${g}_{t}^{n} ( x ) = \frac{1}{M} {‖ {λ}_{t} {w}^{n} {b}_{t}^{n} \cdot x ‖}^{2} - {\overline{P}}^{n}$$

is the long-term transmit power constraint function for wireless device n.

Note that P1 is a stochastic optimization problem due to random channel states. It is challenging to solve, especially when the distribution of hₜⁿ is unknown due to the difficulty of measuring it in wireless edge networks (i.e., at one or more edge nodes 19). In P1, the loss f(\hat{x}ₜ) is determined by the noisy global model \hat{x}ₜ aggregated over the air from the local models {xₜⁿ}. The long-term transmit power constraint violation gₜⁿ(xₜⁿ) depends on both the local channel state ht and the local model xₜⁿ. Therefore, solving P1 requires joint optimization of computation and communication, due to the coupling of model training and wireless transmission. Compared to the standard offline optimization in equation (3), the additional long-term constraints in equation (16) of P1 requires a more complicated online algorithm, especially since the channel state varies over time. In one or more embodiments, [symbol] is imposed to at least in part avoid the transmit power from being infinity.

As introduced in Section 1.1.1, the standard FL aims at minimizing the offline training loss in problem (3). In contrast, due to time varying channels, in 1, our objective is to minimize the accumulated training loss over time. In this invention, without knowing the channel distribution, we aim to develop an online algorithm based on the local channel state hₜⁿ and the local dataset [symbol] ⁿ at each mobile device n, to compute a solution {xₜⁿ} to P1.

### 2. ONLINE MODEL UPDATING FOR ANALOG AGGREGATION (OMUAA)

In this section, details of OMUAA are presented. Different from existing algorithms on FL in wireless networks that optimize model training and wireless transmission independently at each iteration, OMUAA jointly optimize computation and communication over time. The local models yielded by OMUAA can be directly aggregated over the air without additional transmit power control.

### 2.1. OMUAA Algorithm

In the following, OMUAA algorithms are presented at the wireless devices and the edge node 19.

### 2.1.1. Mobile Device n's Algorithm

A virtual queue Qₜⁿ is introduced for the long-term transmit power constraint (16) in P1 at each wireless device n, with the following updating rule

$${Q}_{t}^{n} = max \{ {Q}_{t - 1}^{n} + {g}_{t}^{n} ( {x}_{t}^{n} ) , 0 \} , ∀ n . \qquad ( 17 )$$

The role of Qₜⁿ is similar to a Lagrangian multiplier for P1 or a backlog queue for the constraint violation, which are concepts used in Lyapunov optimization. Although a small part of the derivation of the performance bounds of OMUAA, described herein, borrows some techniques from Lyapunov drift analysis, as explained in Section 3.2, OMUAA is structurally different from Lyapunov optimization.

P1 is then converted to solve a per-iteration optimization problem at each wireless device n, given by

$$P {2}^{n} : {min}_{\{ x ∈ 𝒳 \}} 〈 ∇ {f}^{n} ( {\hat{x}}_{t - 1} ) , x - {\hat{x}}_{t - 1} 〉 + \frac{1}{2 α} {‖ x - {\hat{x}}_{t - 1} ‖}^{2} + γ {Q}_{t - 1}^{n} {g}_{t}^{n} ( x )$$

where α,γ>0 are two step-size parameters.

Note that P2ⁿ is a distributed per-iteration optimization problem under the current local channel state hₜⁿ and the virtual queue length Qₜ₋₁ⁿ subject to the short-term constraints only. Compared with the original P1, the long-term transmit power constraint is converted to penalizing gₜⁿ(x) for queue stability at each wireless device n as one part of the objective in P2ⁿ. Different from problem (5), P2ⁿ uses the local gradient ∇fⁿ(\hat{x}ₜ₋₁) on the noisy global model \hat{x}ₜ₋₁ for training loss minimization.

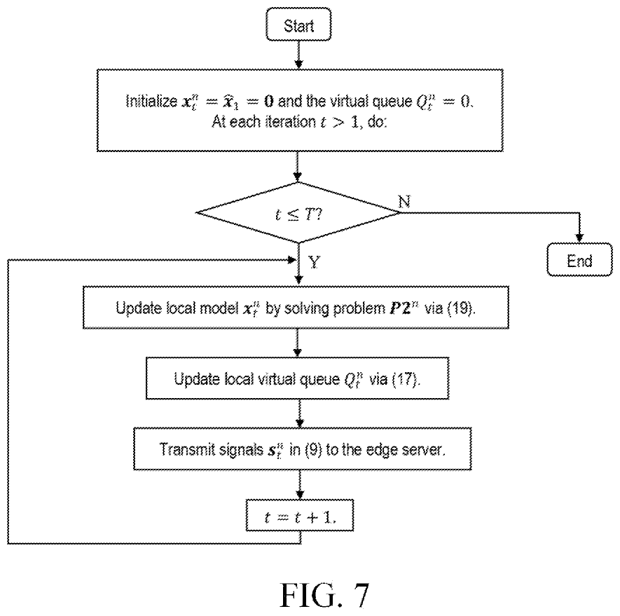

In OMUAA, each wireless device n first initializes the model vectors xₜⁿ=\hat{x}₁=0 and the local virtual queue Q₁ⁿ=0. At each iteration t, after obtaining the local CSI hₜⁿ, each wireless device n updates its local model xₜⁿ by solving P2ⁿ and then updates the local virtual queue Qₜⁿ. Wireless device 22 then follows the pre-processing process introduced in Section 1.2.1 and transmits signals sₜⁿ in (9) to the edge node 19. In some embodiments, P2 (i.e., P2ⁿ) is based on the noisy global model in equation (11). FIG. 7 is a flowchart of Algorithm 1 (i.e., example process/method) where the mobile device n's algorithm (i.e., a process/method performed by WD 22) is illustrated.

### 2.1.2. Edge Node 19's Algorithm

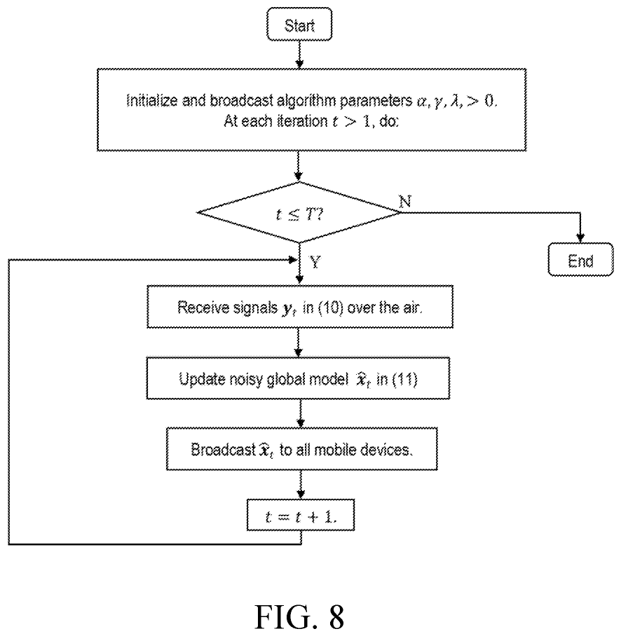

The edge node 19 initializes the step-size parameters α, γ and the power regularization factor λ. The selection of one or more of these parameters and/or factor will be discussed in Section 3, after the performance bounds of OMUAA are derived. At each iteration t, the edge node 19 receives signals yₜ in (10) through analog aggregation of the signals {sₜⁿ} transmitted by the N wireless devices 22. The edge node 19 then follows the post-processing process introduced in Section 1.2.2 to recover a noisy global model \hat{x}ₜ in (11), which is then broadcasted to all wireless devices 22 or to a group of wireless device 22. FIG. 8 is a flow diagram of Algorithm 2 (i.e., example process/method) that illustrates various steps in the edge node 19's algorithm.

### 2.2. Closed-Form Solution to P2ⁿ

Note that the long-term transmit power constraint function gₜⁿ(x) is convex. Because of the regularization term

$$\frac{1}{2 α} {‖ x - {\hat{x}}_{t - 1} ‖}^{2} , P {2}^{n}$$

is a strongly convex optimization problem and thus can be solved efficiently using known optimization tools. In the following, a closed-form solution to P2ⁿ is presented.

For each wireless device n, let

$$\\ {c}_{t , m}^{{}_{} n} = {[ \frac{1}{{\vert {h}_{t , m}^{{}_{} n , 1} \vert}^{2}} , … , \frac{1}{{\vert {h}_{t , m}^{{}_{} n , S} \vert}^{2}} ]}^{T} ∈ {ℂ}^{{}_{} S}$$

be the inverse channel power vector of the m-th transmission frame at the t-th iteration. Then, the gradient of gₜⁿ(x) can be expressed as

$$∇ {g}_{t}^{n} ( x ) = \frac{2 {{λ}_{t}^{2} ( {w}^{n} )}^{2}}{M} {c}_{t}^{n} \cdot x . \qquad ( 18 )$$

where

$${c}_{t}^{n} = {[ {c}_{t , 1}^{{n}^{T}} , … , {c}_{t , M}^{{n}^{T}} ]}^{T} .$$

The gradient of the objective function of P2ⁿ is given by

$$∇ {f}^{n} ( {\hat{x}}_{t - 1} ) + \frac{1}{α} ( x - {\hat{x}}_{t - 1} ) + γ {Q}_{t - 1}^{n} ∇ {g}_{L}^{n} ( x ) .$$

The optimal solution to P2ⁿ can be found by projecting the point with zero gradient onto the affine set [symbol] . Thus, the local model update can be conducted in closed form as follows:

$${x}_{t}^{n} = {[ {( 1 + \frac{2 γ {Q}_{t - 1}^{n} {{λ}_{t}^{2} ( {w}^{n} )}^{2}}{M} {c}_{t}^{n} )}^{- 1} \cdot ( {\hat{x}}_{t - 1} - α ∇ {f}^{n} ( {\hat{x}}_{t - 1} ) ) ]}_{- \overline{x}}^{\overline{x}} . \qquad ( 19 )$$

where a⁻¹ is the point-wise inverse operator and [x]ₐ^{b}=min {b, max {x, a}} is the point-wise projection operator. Note that the minimization of P2ⁿ is distributed in each entry of xₜⁿ. Therefore, the local model xₜⁿ can be updated over multiple transmission frames.

Compared with the standard local gradient descent update for FL over noiseless channels in (4), the local model update in (19) is scaled by both the channel power in cₜⁿ and the long-term transmit power constraint violation measured by Qₜ₋₁ⁿ. The local model parameters are enlarged by stronger channels and are reduced by a larger violation on the long-term transmit power. Therefore, the update of xₜⁿ by OMUAA is both channel and power aware. Note that when the virtual queue is zero, (19) becomes the projected gradient descent update.

### 3. PERFORMANCE BOUNDS

In this section, techniques to derive the performance bounds of OMUAA are presented, particularly these techniques advantageously account for the communication noise and individual long-term transmit power constraints. For performance analysis, a fixed power regularization factor, i.e., λₜ=λ,∀t is considered. In some existing works, a time-varying power regularization factor λₜ is used in (9) to make

$$\frac{1}{M} {‖ {s}_{t}^{n} ‖}^{2} \approx {P}_{t} , ∀ n ,$$

where Pₜ is some pre-defined transmit power at iteration t for all wireless devices 22. Such an approach requires additional communication overhead between the wireless devices 22 and the edge server 19, to agree on a common λₜ before the transmission at each iteration t. Furthermore, as will be shown in Section 4.2, such an approach may cause severe communication error propagation in the learning process, leading to performance deterioration. In practice, we can determine λ over several iterations to reach a certain desired SNR at the edge server. Note that the proposed algorithm is not limited to a fixed λ.

The following assumptions are made to derive the performance bounds for OMUAA.

Assumption 1. The loss function fⁿ(x) is convex and its gradient ∇fⁿ(x) is upper bounded: ∃D>0, s.t.,

$$‖ ∇ {f}^{n} ( x ) ‖ \leq D , \qquad ( 20 )$$

$$∀ x ∈ {ℝ}^{d} , ∀ n .$$

Assumption 2. The constraint function gₜⁿ(x) is bounded: ∃G>0, s.t.,

$$\vert {g}_{t}^{n} ( x ) \vert \leq D , \qquad ( 21 )$$

$$∀ x ∈ 𝒳 , ∀ n , ∀ t .$$

Define

$$\\ {L}_{t}^{n} {=}^{△} \frac{1}{2} {( {Q}_{t}^{{}_{} n} )}^{2}$$

as a quadratic Lyapunov function and Δₜⁿ≙Lₜⁿ−Lₜ₋₁ⁿ as the corresponding Lyapunov drift. First an upper bound is provided on Δₜⁿ in the following lemma.

Lemma 1. The Lyapunov drift is upper bounded as follows:

$${Δ}_{t}^{n} \leq \frac{1}{2} {G}^{2} + {Q}_{t - 1}^{n} {g}_{t}^{n} ( {x}_{t}^{n} ) , ∀ n . \qquad ( 22 )$$

The following lemma may be required.

Lemma 2. Let [symbol] ∈ [symbol] ^{d} be a nonempty convex set. Let f(x): [symbol] ^{d}→ [symbol] be a

$$\\ \frac{1}{α} -$$

strongly convex function over [symbol] with respect to ∥⋅∥. Let

$$z = arg {min}_{x ∈ 𝒳} \{ f ( x ) \} .$$

### Then, for any

$$y ∈ 𝒳 ,$$

$$f ( z ) \leq f ( y ) - \frac{1}{2 α} ‖ y - z {‖}^{2} .$$

For channel state hₜⁿ being independent and identically distributed over time, there exists a stationary randomized optimal global model xₜ* to P1 over noiseless channels, which depends only on the (unknown) distribution of hₜⁿ, and achieves the minimum objective value of P1, denoted by f*. Using the results in Lemmas 1 and 2, the following theorem provides an upper bound on the accumulated loss for OMUAA over noisy channels.

Theorem 3. For any α, γ, λ, >0, the accumulated loss yielded by OMUAA is upper bounded by

$$\frac{1}{T} {\sum }_{t = 1}^{T} 𝔼 \{ f ( {\hat{x}}_{t} ) \} \leq {f}^{★} + \frac{{D}^{2} α}{2} + \frac{{G}^{2} γ}{2} + \frac{{R}^{2}}{2 α T} + \frac{D}{T} ( 2 R + \frac{ρ}{λ} ) + \frac{1}{α T} ( 2 R + \frac{ρ}{λ} ) {Π}_{T} + \frac{{ρ}^{2}}{2 {λ}^{2} α} + \frac{R ρ}{λ α} \qquad ( 23 )$$

where Π_{T}=Σₜ₌₁^{T} [symbol] {∥x*ₜ−x*ₜ₊₁∥} is the accumulated variation of the optimal global model over noiseless channels.

A performance bound on the individual long-term transmit power constraint violations for OMUAA are provided in the following theorem.

Theorem 4. For any α, γ, λ, >0, the individual long-term transmit power constraint violations are upper bounded by

$$\frac{1}{T} {\sum }_{t = 1}^{T} {g}_{t}^{n} ( {x}_{t}^{n} ) \leq \frac{G}{T} + \frac{α γ {G}^{2} + 2 α DR + {( R + \frac{ρ}{λ} )}^{2}}{2 α γ {\overline{P}}^{n} T} , ∀ n . \qquad ( 24 )$$

From Theorems 3 and 4, the following corollary regarding the performance of OMUAA is derived.

Corollary 5. For any ϵ>0, set α=γ=ϵ and

$$λ = \frac{1}{{ϵ}^{2}}$$

in OMUAA. We have

$$\frac{1}{T} {\sum }_{t = 1}^{T} 𝔼 \{ f ( {\hat{x}}_{t} ) \} \leq {f}^{★} + 𝒪 ( ( 1 + {ρ}^{2} + {Π}_{T} ρ ) ϵ ) , \qquad ( 25 )$$

$$∀ T \geq \frac{1}{{ϵ}^{2}} ,$$

$$\frac{1}{T} {\sum }_{t = 1}^{T} {g}_{t}^{n} ( {x}_{t}^{n} ) \leq 𝒪 ( ( 1 + {ρ}^{2} ) ϵ ) , ∀ n , \qquad ( 26 )$$

$$∀ T \geq \frac{1}{{ϵ}^{3}} .$$

Corollary 5 provides an upper bound on the objective value of P1 in (25), i.e., the accumulated loss yielded by the noisy global model. It indicates that for all

$$T \geq \frac{1}{{ϵ}^{2}} ,$$

the loss produced by OMUAA over noisy channels is within [symbol] ((1+ρ²+Π_{T}ρ)ϵ) to the optimum achieved over noiseless channels. Note that Π_{T} can be small when the channel state does not vary too drastically over time. In particular, when the channel is static, we have Π_{T}=0. Furthermore, (26) indicates that for each wireless device n, OMUAA guarantees that the deviation from its long-term transmit power limit P̅ⁿ is within [symbol] ((1+ρ²)ϵ) if

$$T \geq \frac{1}{{ϵ}^{3}} .$$

The standard Lyapunov opumization achieves [symbol] (ϵ) optimality gap with [symbol] (1) convergence time and [symbol] (ϵ) long-term constraint violation with

$$𝒪 ( \frac{1}{{ϵ}^{2}} )$$

convergence time. However, as explained in Section 3.2, it is not applicable to FL over noisy channels.

### 4. SIMULATION RESULTS

In this section, the performance of OMUAA under typical urban micro-cell LTE networks is evaluated with a real-world image classification dataset.

### 4.1. Simulation Setup

### 4.1.1. Communication System

A wireless edge network (e.g., access network 12, core network 14) with one edge node 19 and N=10 wireless devices 22 is considered. Following the typical LTE specifications, the noise power spectral density N₀=−174 dBm/Hz and noise figure N_{F}=10 dB are set, and the focus is on a channel over S=500 subcarriers, each with a bandwidth B_{W}=15 kHz as default system parameters. The fading channel from wireless device n to the edge node 19 at the m-th transmission frame of iteration t is modeled as h_{t,m}ⁿ˜ [symbol] (0, βⁿI), with βⁿ representing the large-scale fading variation consisting of the path-loss and shadowing. βⁿ is modeled as [42] βⁿ=−31.54−33 log₁₀(r)−φⁿ, where r=100 m is the distance from the wireless devices 22 to the edge node 19, and on φⁿ˜ [symbol] (0, σ_{∅}²) is the shadowing effect that is used to model the variation of wireless device 22 positions with σ_{∅}²=8 dB. It is assumed that each channel is independent and identically distributed over transmission frames (and iterations).

### 4.1.2. Computation Task

Simulations are run on the MNIST dataset. The training dataset [symbol] consists of | [symbol] |=60000 data samples and the test dataset ε has |ε|=10000 data samples. Each data sample (u, v) represents a labeled image of size 28×28 pixel, i.e., u∈ [symbol] ⁷⁸⁴, with J=10 different labels, i.e., v∈{1, . . . ,10}. We use the cross-entropy loss for multinomial logistic regression, given by

$$l ( x ; u , v ) = - {\sum }_{j = 1}^{J} 1 \{ v = j \} log \frac{exp ( 〈 x [ j ] , u 〉 )}{{\sum }_{k = 1}^{J} exp ( 〈 x [ k ] , u 〉 )} \qquad ( 27 )$$

where x=[x[1]^{T}, . . . , x[J]^{T}]^{T} with x[j]∈ [symbol] ⁷⁸⁴ being the model vector for label j. The model vector x is thus of dimension d=7840 and occupies M=16 transmission frames at each iteration. Non-independent and identically distributed data distribution that mobile device n only has access to the data of label n is considered. It is assumed that each mobile device n samples a batch dataset [symbol] ₜⁿ where | [symbol] ₜⁿ|=20 data samples at each iteration n. Therefore, the weight of each wireless device n is

$$\\ {w}^{{}_{} n} = \frac{1}{N} .$$

### 4.1.3. Performance Metrics

The performance metrics are the time-averaged test accuracy over the entire test dataset ε

$$\overline{A} ( T ) = \frac{1}{T \vert ℰ \vert} {\sum }_{t = 1}^{T} {\sum }_{i = 1}^{\vert ℰ \vert} 1 \{ arg {max}_{j} \{ \frac{exp ( 〈 {\hat{x}}_{t} [ j ] , {u}^{i} 〉 )}{{\sum }_{k = 1}^{J} exp ( 〈 {\hat{x}}_{t} [ k ] , {u}^{i} 〉 )} \} = {v}^{i} \} , \qquad ( 28 )$$

the time-averaged training loss over the batch datasets { [symbol] ₜⁿ}

$$\overline{f} ( T ) = \frac{1}{T} {\sum }_{t = 1}^{T} {\sum }_{n = 1}^{N} \frac{1}{\vert {ℬ}_{t}^{n} \vert} {\sum }_{i = 1}^{\vert {ℬ}_{t}^{n} \vert} {w}^{n} l ( {\hat{x}}_{t} ; {u}^{i} , {v}^{i} ) , \qquad ( 29 )$$

and the time-averaged transmit power

$$\overline{P} ( T ) = \frac{1}{TNM} {\sum }_{t = 1}^{T} {\sum }_{n = 1}^{N} {‖ λ {w}^{n} {b}_{t}^{n} \cdot {x}_{t}^{n} ‖}^{2} . \qquad ( 30 )$$

A fixed power regularization factor λ is used and equal long-term transmit power limit at the wireless devices 22, i.e., P̅ⁿ=P̅,∀n are assumed in the simulations.

### 4.2. Performance Comparison

OMUAA is compared with the following schemes.
Error-free FL: the FL algorithm introduced in Section 1.1 is run over noiseless channels. It serves as a performance upper bound on the training loss and test accuracy.
OTA FL: a power control approach is adopted, which is the known best alternative that considers FL with long-term transmit power constraints. In existing works, a time-varying power regularization factor λₜ is set at each iteration t to satisfy

$$\frac{1}{M} {‖ λ {w}^{n} {b}_{t}^{n} ∘ {x}_{t}^{n} ‖}^{2} \approx {P}_{t}$$

for each mobile device n, where Pₜ is a predefined transmit power limit. Since different strategies to set Pₜ achieve nearly the same system performance, the following is set Pₜ=P̅,∀t. These existing works consider gradient sparsification and quantization. One or more embodiments described herein consider that the complete local gradient is sent to the edge node 19. Furthermore, sending the local gradient or local model to the edge node 19 may not make much difference to the system performance.
Regularized OTA FL: In addition to OTA FL, a regularization term κ∥x∥² is added to the loss function l(x; u, v), where κ is a tunable hyper parameter. Such a regularization scheme has been adopted in existing works.

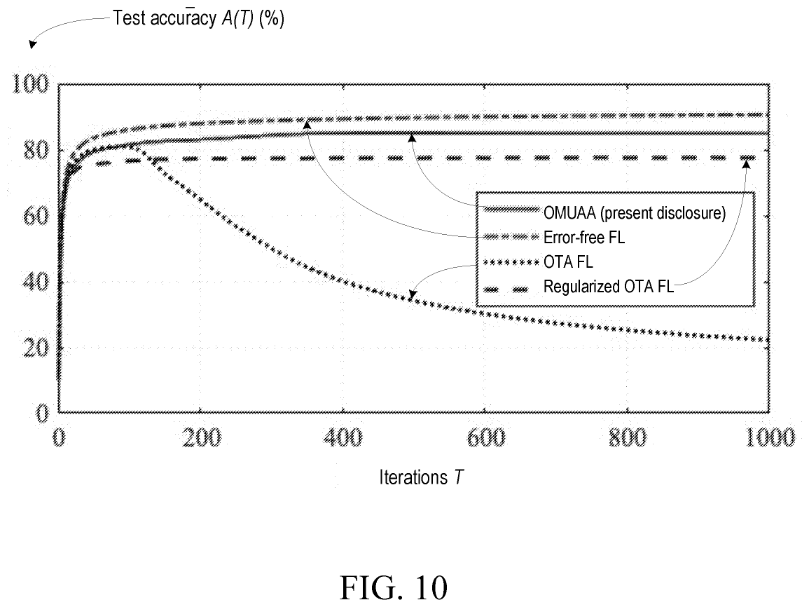

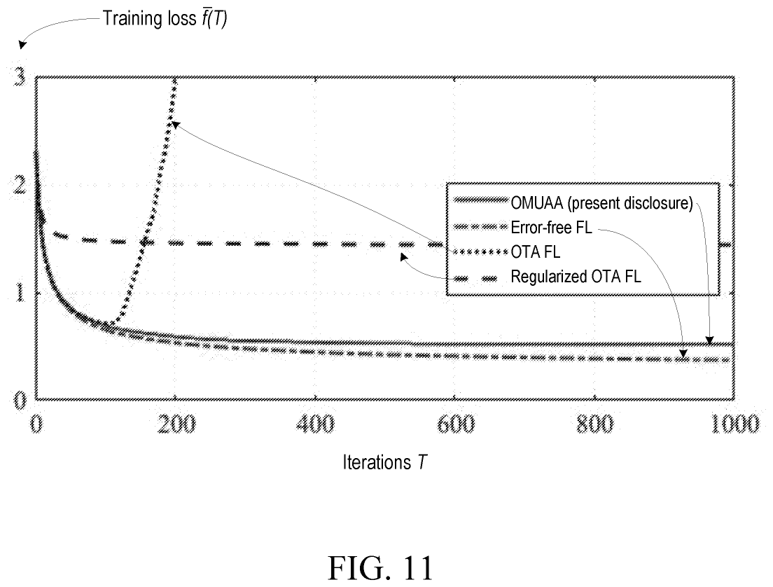

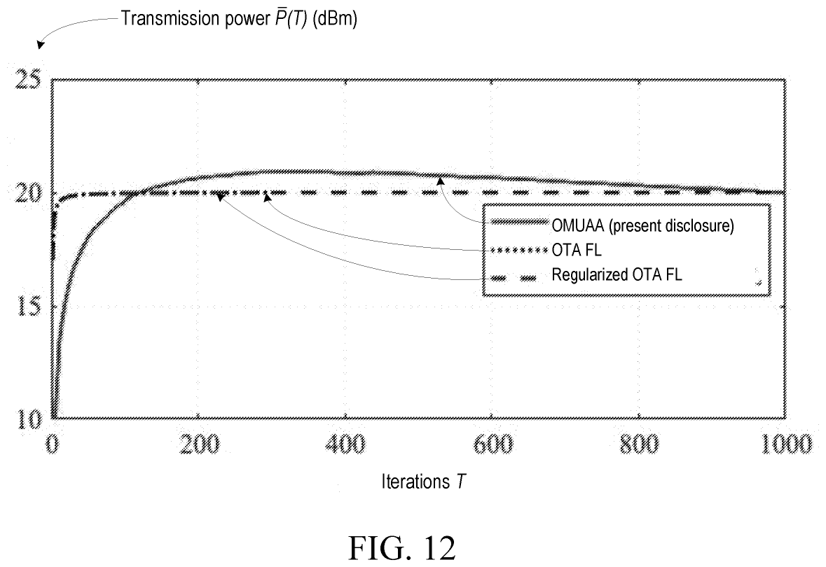

FIG. 10 illustrates test accuracy (Ā(T)), FIG. 11 illustrates training loss (f̅(T)), and FIG. 12 illustrates transmit power (P̅(T)), versus T with P̅=20 dBm. In the presence of communication noise, OMUAA, which is in accordance with the teachings described herein, converges quickly and achieves better classification performance compared with Regularized OTA FL and OTA FL. It is illustrated that the performance of OTA FL keeps deteriorating as T increases. This is because OTA FL relies on the power regularization factor λₜ for transmit power control at each iteration, which enlarges the communication error

$$\\ \frac{1}{{λ}_{t}} {n}_{t}$$

in the global model \hat{x}ₜ in (11) when λₜ is small. Since \hat{x}ₜ is further used in the training process at the next iteration, it causes severe communication error propagation in the learning process. Adding a regularization term as in Regularized OTA FL helps to minimize ∥xₜ∥² at each iteration t, and thus prevents the power regularization factor λₜ from being too small. With properly tuned regularization factor κ as in the simulations, the Regularized OTA FL outperforms the OTA FL. However, such schemes still separate power allocation from model training, thus the resulting model is not channel aware. In contrast, the model yielded by OMUAA is both channel and power aware through jointly optimizing communication and computation. Furthermore, the virtual queue in OMUAA can be viewed as a time-varying regularization on minimizing ∥xₜ∥² over time, leading to improved performance.

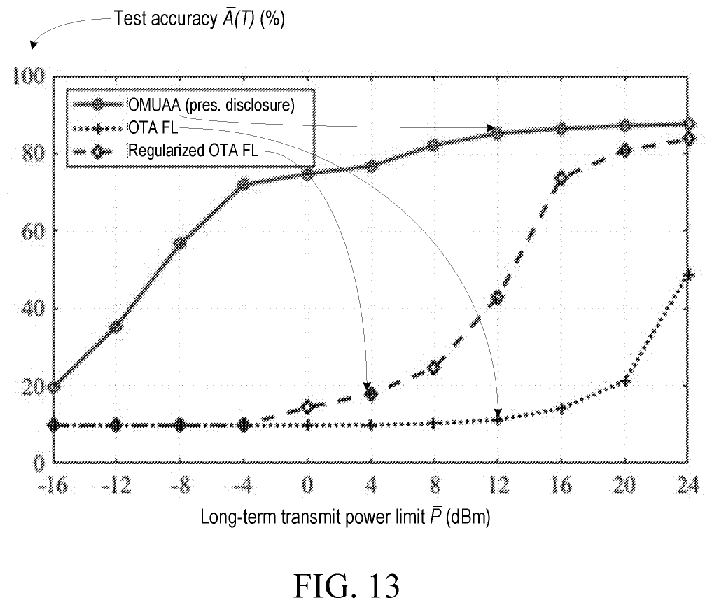

In FIG. 13, the steady-state test accuracy Ā between OMUAA, Regularized OTA FL, and OTA FL, with different values of the long-term transmit power limit P̅ are compared. The test accuracy yielded by Regularized OTA FL and OTA FL decreases drastically as P̅ decreases. Both schemes perform the same as random guessing when P̅=−4 dBm, while OMUAA can still achieve relatively good performance. Over a wide range of P̅, OMUAA substantially outperforms the other two schemes. This demonstrates the performance gain brought by the joint optimization of model training and power allocation described herein, especially in the low power regime.

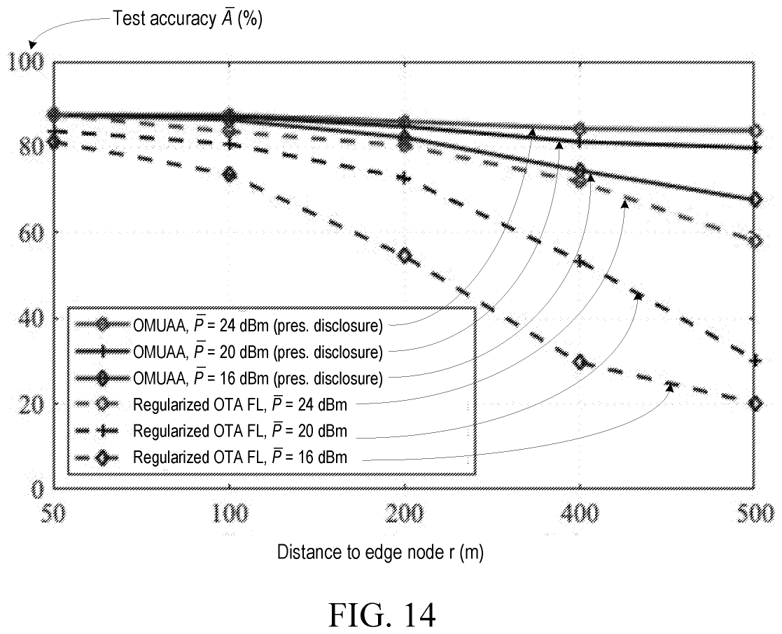

FIG. 14 shows the impact of the distance between wireless devices 22 and the edge node r on the test accuracy Ā with different values of P̅. The test accuracy yielded by OMUAA is more robust to the distance to the edge node 19 compared with the one yielded by Regularized OTA FL. The performance gain of OMUAA over Regularized OTA FL becomes more substantial as r increases.

### Some Advantages

An efficient OMUAA algorithm (Algorithm 1 for the mobile devices and Algorithm 2 for the edge server), for FL with analog aggregation in wireless edge networks over noisy wireless fading MAC is described herein. In contrast to existing solutions, OMUAA jointly optimizes model training and analog aggregation over time, to minimize the accumulated training loss of a global model subject to individual long-term transmit power constraints at the wireless devices 22. OMUAA is an integration of FL, OTA computation, and wireless resource allocation.
OMUAA depends only on the current local CSI, without knowledge of the channel distribution. The local models yielded by OMUAA are both channel and power aware. Furthermore, they are in closed form and can be directly aggregated over the air without additional transmit power control.
The analysis described herein considers the mutual effect of computation and communication over time to provide performance guarantees on both the computation and communication performance metrics. It is proved that OMUAA achieves [symbol] ((1+ρ²+Π_{T}ρ)ϵ) optimality gap with

$$𝒪 ( \frac{1}{{ϵ}^{2}} )$$

convergence time and [symbol] ((1+ρ²)ϵ) long-term power constraint violation with

$$𝒪 ( \frac{1}{{ϵ}^{3}} ) ,$$

where ρ is a channel noise measure and Π_{T} is the accumulate variation of the optimal global model over noiseless channels.
Notes on the performance of OMUAA: the performance of OMUAA under typical LTE network settings with a real-world image classification dataset is validated herein. The impacts of non-independent and identically distributed data, long-term transmit power limit, and distance to the edge node 19 on the performance of OMUAA have been studied. Simulation results show that OMUAA substantially outperforms the state-of-the-art alternatives under different scenarios.

The following is list of example embodiments:

Embodiment A1. An edge node 19 configured to communicate with a plurality of wireless devices 22, the edge node 19 configured to, and/or comprising a radio interface and/or comprising processing circuitry 64 configured to:
receive a plurality of signal vectors from the plurality of wireless devices 22, the plurality of signal vectors being based on a plurality of updated local models associated with the plurality of wireless devices 22;
update a global model based at least on the plurality of signal vectors, the updated global model being channel and power aware; and
cause transmission of the updated global model to the plurality of wireless devices 22.

Embodiment A2. The edge node 19 of Embodiment A1, wherein updating of the global model includes computing a weighted sum of the plurality of signal vectors.

Embodiment A3. The edge node 19 of Embodiment A1, wherein the processing circuitry 64 is further configured to schedule at least one transmission to at least one of the plurality of wireless devices 22 based at least on the updated global model.

Embodiment A4. The edge node 19 of Embodiment A1, wherein the updating of the global model is based on a federated learning at the edge node 19.

Embodiment B1. A method implemented in an edge node 19 that is configured to communicate with a plurality of wireless devices 22, the method comprising:
receiving a plurality of signal vectors from the plurality of wireless devices 22, the plurality of signal vectors being based on a plurality of updated local models associated with the plurality of wireless devices 22;
updating a global model based at least on the plurality of signal vectors, the updated global model being channel and power aware; and
causing transmission of the updated global model to the plurality of wireless devices 22.

Embodiment B2. The method of Embodiment B1, wherein updating of the global model includes computing a weighted sum of the plurality of signal vectors.

Embodiment B3. The method of Embodiment B1, further comprising scheduling at least one transmission to at least one of the plurality of wireless devices 22 based at least on the updated global model.

Embodiment B4. The method of Embodiment B1, wherein the updating of the global model is based on a federated learning at the edge node 19.

Embodiment C1. A wireless device 22 (WD 22) configured to communicate with an edge node 19, the wireless device 22 configured to, and/or comprising a radio interface 46 and/or processing circuitry 50 configured to:
update a local model based at least on solving a distributed per-iteration optimization problem using current local channel state, CSI;
cause transmission of at least one signal vector to the edge node 19, the at least one signal vector being based on the updated local model; and
receive an updated global model that was updated based at least on the at least one signal vector, the updated global model being channel and power aware.

Embodiment C2. The WD 22 of Embodiment C1, wherein the updated global model is based on a computed weighted sum of the plurality of signal vectors associated with a plurality of wireless devices 22.

Embodiment C3. The WD 22 of Embodiment C1, wherein the processing circuitry 50 is further configured to receive a scheduling of at least one transmission that is scheduled based at least on the updated global model.

Embodiment C4. The WD 22 of Embodiment C1, wherein the updated global model is based on a federated learning at the edge node 19.

Embodiment D1. A method implemented in a wireless device 22 (WD 22) that is configured to communicate with an edge node 19, the method comprising:
updating a local model based at least on solving a distributed per-iteration optimization problem using current local channel state, CSI;
causing transmission of at least one signal vector to the edge node 19, the at least one signal vector being based on the updated local model; and
receiving an updated global model that was updated based at least on the at least one signal vector, the updated global model being channel and power aware.

Embodiment D2. The method of Embodiment D1, wherein the updated global model is based on a computed weighted sum of the plurality of signal vectors associated with a plurality of wireless devices 22.

Embodiment D3. The method of Embodiment D1, wherein the processing circuitry 50 is further configured to receive a scheduling of at least one transmission that is scheduled based at least on the updated global model.

Embodiment D4. The method of Embodiment D1, wherein the updated global model is based on a federated learning at the edge node 19.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
FL: Federated Learning
IID: Independent and Identically Distributed
LTE: Long-Term Evolution
MAC: Multiple Access Channel
OFDM: Orthogonal Frequency Division Multiplexing
OMA: Orthogonal Multiple Access
OTA: Over the Air
SNR: Signal to Noise Ratio

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings and/or following claims.

1. An edge node configured to communicate with a plurality of wireless devices, WDs, the edge node comprising:
a communication interface configured to:
receive a plurality of signal vectors from the plurality of WDs, the plurality of signal vectors being based on a plurality of updated local models associated with the plurality of WDs;
processing circuitry in communication with the communication interface, the processing circuitry being configured to:
update a global model based at least on the plurality of signal vectors; and
cause at least one transmission of the updated global model to the plurality of WDs.

2. The edge node of claim 1, wherein:
the processing circuitry is further configured to:
initialize at least one of a first step-size parameter, a second step-size parameter, and a power regularization factor, the plurality of updated local models being based at least in part on the initialized at least one of the first step-size parameter, the second step-size parameter, and the power regularization factor; and
the communication interface is further configured to:
transmit the initialized at least one of the first step-size parameter, the second step-size parameter, and the power regularization factor.

3. The edge node of claim 1, wherein the global model is updated using model averaging based on at least one of a local gradient and a global gradient descent.

4. The edge node of claim 1, wherein each of the plurality of updated local models is based at least in part on respective local channel state information, CSI, and local data.

5. The edge node of claim 1, wherein the received plurality of signal vectors is based on at least one updated local virtual queue.

6. The edge node of claim 1, wherein the processing circuitry is further configured to:
recover a version of the global model based on the received plurality of signal vectors.

7. The edge node of claim 6, wherein the recovered version of the global model is a noisy version of the global model based at least in part on a communication error.

8. The edge node of claim 7, wherein the communication error is based at least in part on a noise value bounded by a predetermined threshold.

9. The edge node of claim 1, wherein updating of the global model includes computing a weighted sum of the plurality of updated local models.

10. The edge node of claim 1, wherein the updating of the global model is based on a federated learning.

11. A method in an edge node configured to communicate with a plurality of wireless devices, WDs, the method comprising:
receiving a plurality of signal vectors from the plurality of WDs, the plurality of signal vectors being based on a plurality of updated local models associated with the plurality of WDs;
updating a global model based at least on the plurality of signal vectors; and
causing at least one transmission of the updated global model to the plurality of WDs.

12. The method of claim 11, further comprising:
initializing at least one of a first step-size parameter, a second step-size parameter, and a power regularization factor; and
transmitting the initialized at least one of the first step-size parameter, the second step-size parameter, and the power regularization factor.

13. The method of claim 11, wherein the global model is updated using model averaging based on at least one of a local gradient and a global gradient descent.

14. The method of claim 11, wherein each of the plurality of updated local models is based at least in part on respective local channel state information, CSI, and local data.

15. The method of claim 11, wherein the received plurality of signal vectors is based on at least one updated local virtual queue.

16. The method of claim 11, further comprising:
recovering a version of the global model based on the received plurality of signal vectors.

17. The method of claim 16, wherein the recovered version of the global model is a noisy version of the global model based at least in part on a communication error.

18. The method of claim 17, wherein the communication error is based at least in part on a noise value bounded by a predetermined threshold.

19. The method of claim 11, wherein updating of the global model includes computing a weighted sum of the plurality of updated local models.

20. The method of claim 11, wherein the updating of the global model is based on a federated learning.

21-40. (canceled)
